(19) United States
(12) Patent Application Publication
(10) Pub. No.: US 2023/0135253 A1
(43) Pub. Date: May 4, 2023

(54) METHOD OF MANAGING DISTRIBUTED ENERGY RESOURCES AND SYSTEM FOR PERFORMING THE SAME

(71) Applicant: Electronics and Telecommunications Research Institute, Daejeon (KR)

(72) Inventor: Taehyoung SHIM, Sejong-si (KR)

(73) Assignee: Electronics and Telecommunications Research Institute, Daejeon (KR)

(21) Appl. No.: 17/975,974

(22) Filed: Oct. 28, 2022

(30) Foreign Application Priority Data
Nov. 1, 2021 (KR) 10-2021-0148148
May 20, 2022 (KR) 10-2022-0062096

(51) Int. Cl. G06Q 50/06; H02J 3/38; G06Q 10/06

(52) U.S. Cl. CPC G06Q 50/06; H02J 3/381; G06Q 10/06315

(57) ABSTRACT

Provided is a method of managing distributed energy resources (DER) and a device for performing the method. A system for managing distributed energy resources includes a memory configured to store instructions, and a processor electrically connected to the memory and configured to execute the instructions, and when the instructions are executed by the processor, the processor is configured to determine at least one DER that is to supply power to a consumer from among a plurality of DERs, using a rank of each of the DERs indicating importance as a power source supplying power to the consumer and information about power consumed by the consumer.

### CROSS-REFERENCE TO RELATED APPLICATIONS

This application claims the benefit of Korean Patent Application No. 10-2021-0148148 filed on Nov. 1, 2021, and Korean Patent Application No. 10-2022-0062096 filed on May 20, 2022, in the Korean Intellectual Property Office, the entire disclosure of which is incorporated herein by reference for all purposes.

### BACKGROUND

### 1. Field of the Invention

One or more example embodiments relate to a method of managing distributed energy resources (DERs) and a system for performing the same.

### 2. Description of the Related Art

Distributed energy resources (DERs) refer to small-scale power generation facilities that are distributed and deployed near power consumption areas. The DERs may include new energy such as hydrogen energy and fuel cells, and renewable energy such as sunlight and solar heat.

A DER management system (DERMS) may communicate with an energy management system (EMS) or a distributed management system (DMS). The EMS or DMS may aggregate information about the DERs and control it.

The above description is information the inventor(s) acquired during the course of conceiving the present disclosure, or already possessed at the time, and is not necessarily art publicly known before the present application was filed.

### SUMMARY

Example embodiments provide a method of managing distributed energy resources (DERs) and a system for performing the same that may calculate a rank indicating the importance of the DERs based on the connection state between the DERs.

According to an aspect, there is provided a method of managing the DERs and a system for performing the same that may determine the DERs that is to supply power to consumers based on a rank indicating the importance of the DERs.

According to another aspect, there is provided a method of managing the DERs and a system for performing the same that may efficiently supply power to consumers by operating the DERs based on a rank of the DERs.

Additional aspects of example embodiments will be set forth in part in the description which follows and, in part, will be apparent from the description, or may be learned by practice of the disclosure.

According to example embodiments, a system for managing the DERs may include a memory configured to store instructions and a processor electrically connected to the memory and configured to execute the instructions, and when the instructions are executed by the processor, the processor may be configured to determine one or more DERs to supply power to the consumer from among the plurality of DERs using a rank of a plurality of DERs indicating importance as a power source for supplying power to a consumer and information on power consumed by the consumer.

The processor may recalculate the rank using a connection relationship between DERs and a ratio of power amount consumed in the DERs by themselves.

The connection relationship may include information about power amount input and output between DERs.

The processor may calculate a rank matrix for the importance using a matrix representing the connection relationship, a matrix representing a ratio of the power amount, and a recursive operation on a matrix, and calculate the rank using the rank matrix.

The processor may repeat the recursive operation until the rank matrix converges.

The processor may calculate the rank using a converged rank matrix component.

The processor may recalculate a rank of the plurality of DERs whenever the connection relationship or a ratio of the power amount is updated.

According to example embodiments, a method of managing the DERs may include calculating a rank of a plurality of DERs indicating importance as a power source for supplying power to consumers, and determining at least one DER that is to supply power to the consumers from among the plurality of DERs using the rank and information about power consumed by the consumers.

The calculating may include calculating the rank using a connection relationship between DERs and a ratio of power amount consumed in the DERs by themselves.

The connection relationship may include information about power amount input and output between DERs.

The calculating of the rank using a connection relationship between the DERs and a ratio of power amount consumed in the DERs by themselves may include calculating a rank matrix for the importance using a matrix representing the connection relationship, a matrix representing a ratio of the power amount, and a recursive operation on the matrix, and calculating the rank using the rank matrix.

The calculating of the rank matrix may include repeating the recursive operation until the rank matrix converges.

The calculating of the rank using the rank matrix may include calculating the rank using a converged rank matrix component.

The method of the DERs may include recalculating a rank of the plurality of DERs whenever the connection relationship or a ratio of the power amount is updated.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a message exchange procedure for managing DERs;

FIG. 2 is a diagram illustrating an example of DERs group;

FIG. 3 is a flowchart illustrating a method of managing DERs according to various example embodiments;

FIG. 4 is a diagram illustrating a process in which components of a rank matrix of DERs converge; and

FIG. 5 is a block diagram schematically illustrating an example of a system for managing DERs according to various example embodiments.

### DETAILED DESCRIPTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the example embodiments with reference to the accompanying drawings, like reference numerals refer to like elements and a repeated description related thereto will be omitted.

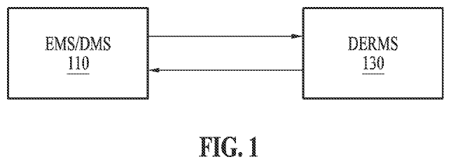

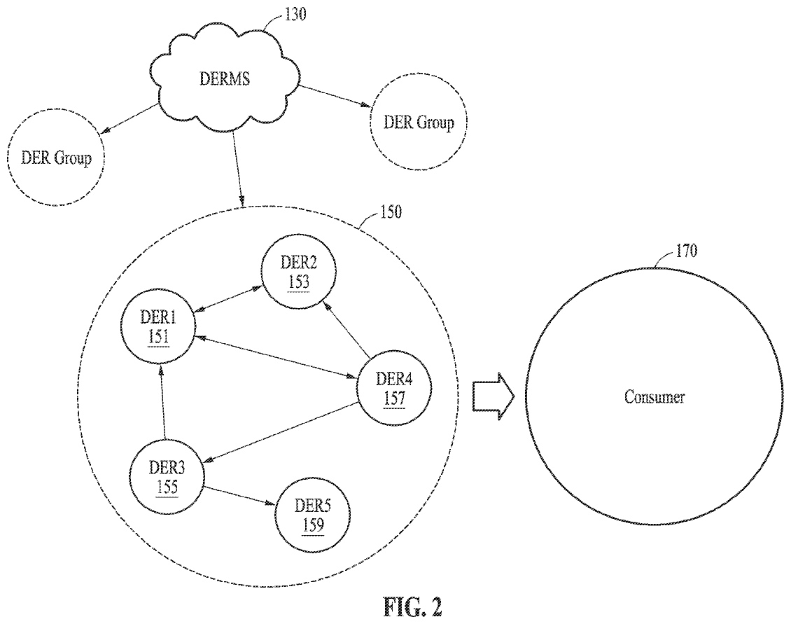

FIG. 1 is a diagram illustrating a message exchange procedure for managing DERs, and FIG. 2 is a diagram illustrating an example of DERs group.

Referring to FIGS. 1 and 2, an energy management system (EMS) 110 (or a distributed management system (DMS)) may be grouped and managed DERs 151 to 159 to efficiently supply power to consumers 170 (e.g., factories, homes). The EMS 110 may transmit a request message for forming a DERs group to a DERs management system (DERMS) 130. The DERMS 130 may determine a DERs group 150, and transmit information about the DERs group 150 to the EMS 110. For example, the DERMS 130 may determine DERs group by opening/closing a circuit breaker (e.g., a circuit breaker for controlling input/output power between DERs). However, the DERMS 130 may be a separate device located outside the EMS 110, but is not limited thereto, and it may be located in the EMS 110 or may be the EMS 110 itself.

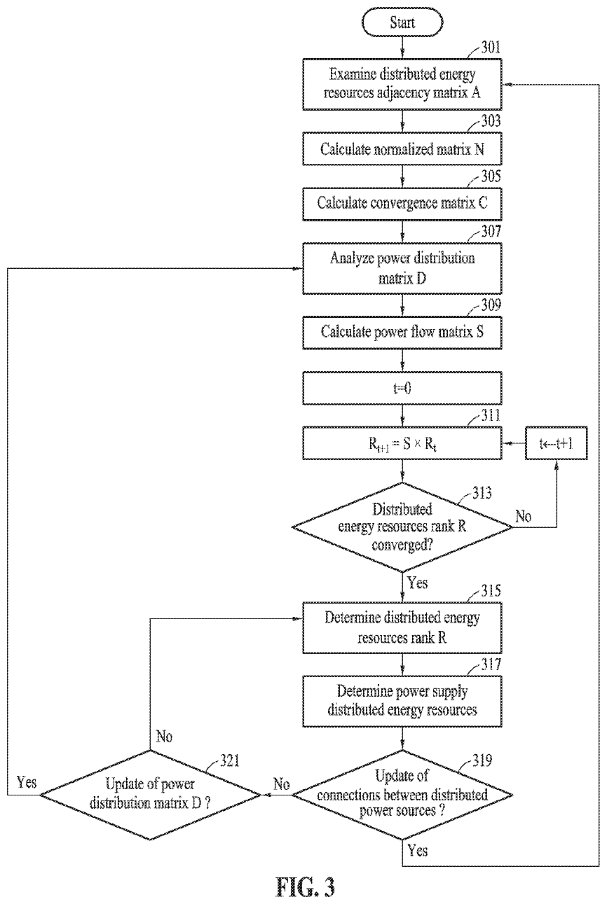

FIG. 3 is a flowchart illustrating a method of managing DERs according to various example embodiments.

Referring to FIG. 3, according to various example embodiments, the DERMS 130 may calculate a rank of the DERs 151 to 159 using a matrix (e.g., a matrix representing the connection relationship of the DERs and a matrix representing the power amount consumed in the DERs by themselves) for the DERs (e.g., the DERs 151 to 159 in FIG. 2). The rank of the DERs may indicate the importance of the DERs 151 to 159 (e.g., the rank of the DERs to be supplied in preference to customers). However, the operation order of FIG. 3 is an example for describing a method of generating a DERs group, and is not limited thereto, and a plurality of operations may be performed in parallel.

In operation 301, the DERMS 130 may examine (or check) an adjacency matrix A of the DERs 151 to 159. The adjacency matrix A may represent a connection relationship (e.g., input/output power state) between the DERs 151 to 159. Specifically, a row of the adjacency matrix A may represent power input to the DERs 151 to 159, and a column of the adjacency matrix A may represent power output from the DERs 151 to 159. For example, a first row of the adjacency matrix A may represent power input to the DER1 151, and a first column of the adjacency matrix A may represent power output from the DER1 151. Since power is input to the DER1 151 from the DER2 153, DER3 155, and DER4 157, the first row of the adjacency matrix A may be [0 1 1 1 0]. In addition, since power is output from the DER1 151 to the DER2 153 and DER4 157, the first column of the adjacency matrix A may be [0 1 0 1 0]. Similarly, the n-th row of the adjacency matrix A may represent power input to the n-th DER, and the n-th column of the adjacency matrix A may represent power output from the n-th DER. The adjacency matrix A of the DERs 151 to 159 may be expressed as the following Equation 1.

$$A = [ \begin{matrix}0 & 1 & 1 & 1 & 0 \\ 1 & 0 & 0 & 1 & 0 \\ 0 & 0 & 0 & 1 & 0 \\ 1 & 0 & 0 & 0 & 0 \\ 0 & 0 & 1 & 0 & 0\end{matrix} ] \qquad [ Equation 1 ]$$

In operation 303, the DERMS 130 may calculate a normalized matrix N using the adjacency matrix A. The normalized matrix N is a normalized column of the adjacent matrix A and may mean a ratio of power output from the DERs 151 to 159. The normalized matrix N may be obtained by dividing each column by the sum of the components included in the column of the adjacent matrix A. This may be expressed as the following Equation 2.

$${N}_{j} = \frac{{A}_{j}}{{\sum }_{k = 1}^{n} {A}_{kj}} , j = 1 , … , n \qquad [ Equation 2 ]$$

The normalized matrix N of the adjacency matrix (e.g., the adjacency matrix A of Equation 1) may be expressed as the following Equation 3.

$$N = [ \begin{matrix}0 & 1 & \frac{1}{2} & \frac{1}{3} & 0 \\ \frac{1}{2} & 0 & 0 & \frac{1}{3} & 0 \\ 0 & 0 & 0 & \frac{1}{3} & 0 \\ \frac{1}{2} & 0 & 0 & 0 & 0 \\ 0 & 0 & \frac{1}{2} & 0 & 0\end{matrix} ] \qquad [ Equation 3 ]$$

In operation 305, the DERMS 130 may calculate a convergence matrix C using the normalized matrix N. The convergence matrix C may be calculated for the DERs (e.g., the DER5 159) having only power input to the DERs and no power output from the DERs among the DERs (e.g., the DER1 to DER5 151 to 159). For example, in the case of DER5 159, since there is only power input from the DER3 155 and no power output from the DER5 159, a fifth column of the convergence matrix C may be [0 0 0 0 1]. However, the above-described method is an example of a method of obtaining the convergence matrix C, and is not limited thereto. The convergence matrix C of the normalized matrix (e.g., the normalized matrix N of Equation 3) may be expressed as the following Equation 4.

$$C = [ \begin{matrix}0 & 1 & \frac{1}{2} & \frac{1}{3} & 0 \\ \frac{1}{2} & 0 & 0 & \frac{1}{3} & 0 \\ 0 & 0 & 0 & \frac{1}{3} & 0 \\ \frac{1}{2} & 0 & 0 & 0 & 0 \\ 0 & 0 & \frac{1}{2} & 0 & 1\end{matrix} ] \qquad [ Equation 4 ]$$

In operation 307, the DERMS 130 may analyze a power distribution matrix D of the DERs 151 to 159. The power distribution matrix D represents a ratio of power consumed in the DERs 151 to 159 by themselves and may have a value between 0 and 1. For example, when a ratio of the power consumed in the DERs 151 to 159 by themselves is 1:2:3:4:5, the power distribution matrix D may be expressed by the following Equation 5.

$$D = [ \begin{matrix}0.1 & 0 & 0 & 0 & 0 \\ 0 & 0.2 & 0 & 0 & 0 \\ 0 & 0 & 0.3 & 0 & 0 \\ 0 & 0 & 0 & 0.4 & 0 \\ 0 & 0 & 0 & 0 & 0.5\end{matrix} ] \qquad [ Equation 5 ]$$

In operation 309, the DERMS 130 may calculate the power flow matrix S using the convergence matrix C and the power distribution matrix D. This may be expressed by the following Equation 6.

Sⱼ=(1−Dⱼ)Cⱼ+DⱼEⱼ [Equation 6]

Here, Eⱼ may be a matrix having 1 in the component of the j-th row and 0 in the remaining components.

In operation 311, the DERMS 130 may calculate a rank matrix R of the DERs 151 to 159. The rank matrix R may indicate the importance of the DERs 151 to 159 as a power source. The rank matrix R may be calculated through a recursive operation. This may be expressed by the following Equation 7.

Rₜ₊₁=S*Rₜ [Equation 7]

Here, S may represent the power flow matrix S, Rₜ may represent a rank matrix calculated in the previous step, and Rₜ₊₁ may represent a rank matrix of the current step.

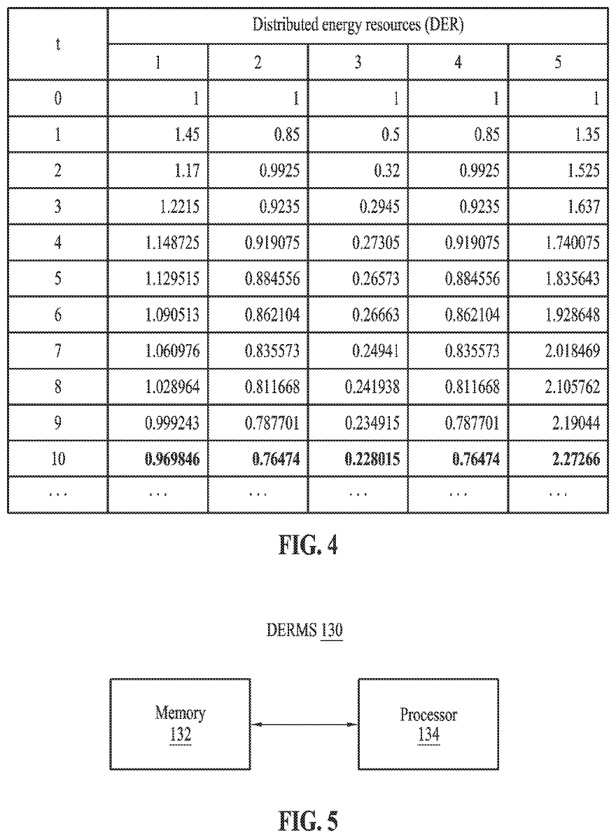

In operation 313, the DERMS 130 may check whether the components of the rank matrix R converge. The DERMS 130 may repeat a recursive operation (e.g., the recursive operation of Equation 7) until the components of the rank matrix R converge. A process in which the components of the rank matrix R converge will be described in detail with reference to FIG. 4.

In operation 315, the DERMS 130 may determine a rank of the DERs 151 to 159 using the converged rank matrix R. For example, a rank of the DERs 151 to 159 may be a component of the converged rank matrix R.

In operation 317, the DERMS 130 may determine the DERs (e.g., at least one DER among the DERs 151 to 159) to preferentially supply power to customers (e.g., the consumer 170 in FIG. 2) based on the rank of the DERs. For example, the DERMS 130 may determine the DERs to supply power to the customer 170 using the rank of the DERs and information (e.g., monthly power consumption, weekend and weekday power consumption, peak power consumption, cost of electricity, and power parameters of consumers) on the power consumption of the consumer 170. According to various example embodiments, the DERMS 130 may efficiently supply power to the consumer 170 by operating the DERs 151 to 159 using the rank of the DERs 151 to 159 and information about the power consumption of the consumer.

In operation 319, the DERMS 130 may check whether the connection relationship (e.g., input/output power state) of the DERs 151 to 159 in the DERs group 150 is updated. When the connection relationship between the DERs 151 to 159 is updated, the DERMS 130 may recalculate the adjacent matrix A of the DERs 151 to 159 based on the updated connection relationship between the DERs 151 to 159, and may recalculate a rank of the DERs 151 to 159.

In operation 321, the DERMS 130 may check whether the DERs power distribution matrix D is updated. That is, the DERMS 130 may check whether a ratio of power consumed in the DERs 151 to 159 by themselves is updated. When the DERs power distribution matrix D is updated, a rank of the DERs 151 to 159 may be recalculated based on the new power distribution matrix D.

FIG. 4 is a diagram illustrating a process in which components of a rank matrix of DERs converge.

Referring to FIG. 4, an initial value of a component of the rank matrix R may be set to 1 but is not limited thereto. The component of the rank matrix R is converged to a certain value through a recursive operation, and the converged value may indicate a rank indicating the importance of the DERs 151 to 159. The DERMS 130 may determine that the rank matrix R is converged when the difference between the component value of the rank matrix (e.g., Rₜ in Equation 7) calculated in the previous step and the component value of the rank matrix (e.g., Rₜ₊₁ in Equation 7) calculated in the current step is less than or equal to a certain value. The rank of the DERs may vary depending on the connection relationship of the DERs. For example, when the connection relationship between the DERs 151 to 159 is as illustrated in FIG. 2, the rank of the DER5 159 may be the highest and the rank of the DER3 155 may be the lowest.

FIG. 5 is a block diagram schematically illustrating an example for a system for managing DERs according to various example embodiments.

Referring to FIG. 5, according to various example embodiments, the DERMS 130 may include a memory 132 and a processor 134.

The memory 132 may store instructions (e.g., a program) executable by the processor 134. For example, the instructions may include instructions for performing an operation of the processor 134 and/or an operation of each component of the processor 134.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

According to various example embodiments, the memory 132 may be implemented as a volatile memory device or a non-volatile memory device. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

The processor 134 may execute computer-readable code (e.g., software) stored in the memory 132 and instructions triggered by the processor 134. The processor 134 may be a hardware-implemented data processing device having a circuit that is physically structured to execute desired operations. The desired operations may include code or instructions included in a program. For example, the hardware-implemented data processing device may include a microprocessor, a CPU, a processor core, a multi-core processor, a multiprocessor, an application-specific integrated circuit (ASIC), and a field-programmable gate array (FPGA).

According to various example embodiments, operations performed by the processor 134 may be substantially the same as the operations performed by the DERMS 130 described with reference to FIGS. 1 through 3. Accordingly, further description thereof is not repeated herein.

The example embodiments described herein may be implemented using a hardware component, a software component and/or a combination thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A system for managing distributed energy resources (DERs), the system comprising:
a memory configured to store instructions; and
a processor electrically connected to the memory and configured to execute the instructions,
wherein, when the instructions are executed by the processor, the processor is configured to:
determine at least one DER that is to supply power to a consumer from among a plurality of DERs, using a rank of each of the DERs indicating importance as a power source supplying power to the consumer and information about power consumed by the consumer.

2. The system of claim 1, wherein the processor is configured to:
calculate the rank, using a connection relationship between the DERs and a ratio of power amount consumed in the DERs by themselves.

3. The system of claim 2, wherein the connection relationship comprises information about the power amount input and output between the DERs.

4. The system of claim 3, wherein the processor is configured to:
calculate a rank matrix for the importance using a matrix representing the connection relationship, a matrix representing the ratio of the power amount, and a matrix-related recursive operation, and calculate the rank using the calculated rank matrix.

5. The system of claim 4, wherein the processor is configured to:
iteratively perform the recursive operation until the rank matrix converges.

6. The system of claim 5, wherein the processor is configured to:
calculate the rank using an element of the converged rank matrix.

7. The system of claim 6, wherein the processor is configured to:
recalculate the rank of the plurality of DERs each time the connection relationship or the ratio of the power amount is updated.

8. A method of managing distributed energy resources, the method comprising:
calculating a rank of a plurality of DERs indicating importance as a power source supplying power to a consumer; and
determining at least one DER that is to supply power to the consumer from among the plurality of DERs, using the rank and information about power consumed by the consumer.

9. The method of claim 8, wherein the calculating comprises:
calculating the rank using a connection relationship between the DERs and a ratio of power amount consumed in the DERs by themselves.

10. The method of claim 9, wherein the connection relationship comprises information about the power amount input and output between the DERs.

11. The method of claim 10, wherein the calculating of the rank using the connection relationship between the DERs and the ratio of the power amount consumed in the DER by themselves comprises:
calculating a rank matrix for the importance using a matrix representing the connection relationship, a matrix representing the ratio of the power amount, and a matrix-related recursive operation; and
calculating the rank using the calculated rank matrix.

12. The method of claim 11, wherein the calculating of the rank matrix comprises:
iteratively performing the recursive operation until the rank matrix converges.

13. The method of claim 12, wherein the calculating of the rank using the rank matrix comprises:
calculating the rank using an element of the converged rank matrix.

14. The method of claim 13, further comprising:
recalculating the rank of the plurality of DERs each time the connection relationship or the ratio of the power amount is updated.
